(19) United States
(12) Patent Application Publication
(10) Pub. No.: US 2004/0209539 A1
(43) Pub. Date: Oct. 21, 2004

(54) High opacity nonwoven binder composition

(76) Inventors: Philip Confalone, Raritan, NJ (US); Rajeev Farwaha, Belle Mead, NJ (US); Paul Scott, Epsom (GB)

Correspondence Address: Thomas F. Roland, NATIONAL STARCH AND CHEMICAL COMPANY, P.O. Box 6500, Bridgewater, NJ, 08807-0500, US

(21) Appl. No.: 10/417,752

(22) Filed: Apr. 15, 2003

(51) Int. Cl. B32B 5/02; B32B 27/04; B32B 27/12; B32B 27/02; D04H 1/00; D04H 3/00; D04H 5/00; D04H 13/00

(52) U.S. Cl. 442/164; 442/327; 442/149

(57) ABSTRACT

The present invention is directed to a fibrous nonwoven material made of chemically bonded fibers, where the fibers are bound with a polymeric binder in an amount which is sufficient to bind the fibers together to form a self-sustaining web, and where the binder comprises from 55 to 96 percent by weight of a film-forming polymer; from 4 to 45 percent by weight of one or more opacifying agents; and 0 to 2 percent by weight of one or more adjuvants, based on the binder composition solids. The binder composition provides opacity to the nonwoven material. The binder composition is especially useful in light basis weight nonwovens, and provide high opacity and tensile strength both dry and wetted.

### FIELD OF THE INVENTION

The present invention relates to a nonwoven binder composition that provides high opacity to nonwoven materials. The binder composition contains one or more opacifying agents in addition to one or more polymer binders. The opacifying binder composition is especially useful in light basis weight nonwovens, and provides high opacity and tensile strength both dry and wetted.

### BACKGROUND OF THE INVENTION

Nonwoven materials and other fibrous products consist of a loosely assembled mass of fibers that are bound together mechanically, thermally, and/or chemically with a polymeric binder to form a self-sustaining web. They can be used to produce many items such as consumer towels, disposable wipes, absorbent media for feminine hygiene applications, diapers, medical drapes, tablecloths, and high-grade napkins. One problem with nonwoven materials, and especially light basis weight materials, is that they appear translucent and almost transparent, especially when wetted. Many consumers prefer the aesthetics of an opaque nonwoven to a less opaque material.

U.S. Pat. No. 3,666,545 describes light weight nonwoven materials that are coated with a polymer coating containing 20 to 30 percent of opacifying filler. The coating is applied to spunbonded fabric in a similar manner that a paint is applied to a substrate. Paints generally contain large amounts of opacifying pigments. The polymer coating does not serve as a binder for the nonwoven material.

In a similar manner, U.S. Pat. No. 4,562,107 describes an opacifying coating that can be printed onto a woven fabric. The opacifying coating contains pigment and a binder used to bind the pigment to the fabric. The polymer is not used as a nonwoven binder.

U.S. patent application Ser. No. 2002/0086908 describes a process for making polymer/clay nanocomposite dispersions. The dispersions are useful in preparing coatings, adhesives, caulking, and sealants. The application also discloses the use of the nanocomposites in nonwoven fabrics.

U.S. patent application Ser. No. 2002/0155281 describes a non-woven article that is wetted with a solution containing solid particulates or microparticulates. The particulates increase the tactile properties and opacity of pre-moistened wipes.

There is a need for a nonwoven binder that provides both good binder properties and also improves the opacity of the nonwoven material. There is especially an unmet need for lighter basis weight nonwoven materials having an opacity similar to the more expensive heavier basis weight fabrics.

Surprisingly it has been found that stable emulsion binder compositions containing opacitying pigments can be used to both bind the fibers to form a self-sustaining web, and also add opacity to the nonwoven material. The opacifying binder provide both good wet tensile strength and good wetted opacity, making it a suitable choice for disposable wetted wipes and similar applications. The opacifying binder is also especially useful in feminine care applications.

### SUMMARY OF THE INVENTION

It is an object of the invention to provide a stable emulsion nonwoven binder that functions as both a binder for the fibrous web and also provides opacity to the nonwoven material.

It is a further object of the invention to provide a binder for light basis weight materials that provides opacity similar to heavy basis weight materials, especially when wetted.

The present invention is directed to a fibrous nonwoven material made of chemically bonded fibers, where the fibers are bound with a polymeric binder in an amount which is sufficient to bind the fibers together to form a self-sustaining web, where the binder comprises:

a) from 55 to 96 percent by weight of a film-forming polymer, based on the binder composition solids;

b) from 4 to 45 percent by weight of one or more opacifying agents, based on the weight of the binder composition solids; and

c) 0 to 2 percent by weight of one or more adjuvants, based on the binder composition solids.

### DETAILED DESCRIPTION OF THE INVENTION

The invention is directed to a fibrous nonwoven substrate that is bound together by an emulsion polymeric binder composition. The binder composition is a stable combination of one or more film-forming polymers and one or more opacifying agents.

The film-forming polymer of the invention may be either a natural polymer, a synthetic polymer, or a mixture thereof. Natural polymers useful as nonwoven binders include, but are not limited to starches and modified starches, and cellulosics and modified cellulosics. Preferably the starch has a wet fluidity of from 40 to 80 WF, and more preferably from 60-70 WF. The starch solids of a starch-containing liquid binder composition is typically from 10 to 35 percent. The starch binder composition is generally applied to a non-woven at a solids level of from 5 to 45 percent, and preferably at a solids level of from 10 to 20 percent.

The film-forming polymer may also be one or more synthetic polymers. The polymer may be a homopolymer, or a copolymer. As used herein copolymer refers to a polymer formed from two or more monomers, and may be a random, block, tapered block, or other known architecture.

The synthetic polymer may be polymerized from one or more of any conventionally employed monomers. Suitable monomers include, but are not limited to, those selected from the class of ethylene; vinyl chloride; vinyl esters; vinyl esters of aliphatic carboxylic acids containing 1-20 carbon atoms; olefinically-unsaturated carboxylic acids; styrene and styrene derivatives; dialkyl esters of maleic and fumaric acid containing 1-8 carbon atoms in each alkyl group; and C₁-C₈ alkyl acrylates and methacrylates. Preferred polymers include polyvinyl alcohol, vinyl acetate/ethylene copolymers, styrenics, vinyl acrylics, and acrylic copolymers. In addition, certain copolymerizable monomers which assist in the stability of the copolymer emulsion, e.g., sodium vinyl sulfonate, may also be used in very low amounts of from 0.1 to about 2 percent by weight of the monomer mixture.

In wetted nonwoven applications, wet tensile strength is required. Wet tensile strength is increased by use of a film-forming polymer which is crosslinkable. By “crosslinkable” as used herein is meant a polymer that is capable of undergoing crosslinking, either by a self-crosslinking mechanism, or by the incorporation of at least one functional monomer into the polymer backbone which can undergo a post-polymerization crosslinking reaction to form crosslinks.

The crosslinking monomers used herein include N-methylol acrylamide, N-methylol methacrylamide, N-methylol allyl carbamate, iso-butoxy methyl acrylamide and n-butoxy methyl acrylamide, or a mixture thereof. The preferred crosslinking monomers are N-methylol acrylamide as well as a blend of N-methylol acrylamide and acrylamide available from Cytec Industries. The crosslinking monomer is generally used at levels above 2 percent, preferably from 3 to 20 percent, more preferably from 4.5 to 15 percent and most preferably from 6 to 12 percent based upon the weight of the polymer. In one embodiment an emulsion acrylic or vinyl acrylic polymer having about 3 parts per hundred (pph) N-methylol acrylamide was used as the film-forming polymer.

The synthetic film-forming polymer may be produced by means know in the art, such as emulsion, suspension, and solution polymerization. The polymer may be prepared using conventional batch, semi-batch or semi-continuous polymerization procedures. Batch emulsion polymerization is preferred as it generally produces higher molecular weight polymers, and higher molecular weight polymers lead to higher wet strength binders. Generally, the monomers are polymerized in an aqueous medium in the presence of a redox initiator system and at least one emulsifying agent, to form the emulsion polymer.

To control the generation of free radicals, a transition metal often is incorporated into the redox system, and such metals include an iron salt, e.g., ferrous and ferric chloride and ferrous ammonium sulfate. The use of transition metals and levels of addition to form a redox system for polymerization mediums are well-known.

The polymerization is carried out at a pH of between 2 and 7, preferably between 3 and 5. In order to maintain the pH range, it may be useful to work in the presence of customary buffer systems, for example, in the presence of alkali metal acetates, alkali metal carbonates, alkali metal phosphates. Polymerization regulators, like mercaptans, chloroform, methylene chloride and trichloroethylene, can also be added in some cases.

Useful dispersing agents are emulsifiers, surfactants, and protective colloids generally used in emulsion polymerization, or a mixture thereof. The emulsifiers can be anionic, cationic or nonionic surface active compounds, as known in the art. Various protective colloids may also be used in addition to the emulsifiers described above. Suitable colloids include polyvinyl alcohol, partially acetylated polyvinyl alcohol, e.g., up to 50 percent acetylated, casein, hydroxyethyl starch, carboxymethyl cellulose, gum arabic, and the like, as known in the art of synthetic emulsion polymer technology. In general, these colloids are used at levels of 0.05 to 4 percent by weight, based on the total emulsion.

The particle size of the latex can be regulated by the quantity of nonionic or anionic emulsifying agent or protective colloid employed. To obtain smaller particles sizes, greater amounts of emulsifying agents are used. As a general rule, the greater amount of the emulsifying agent employed, the smaller the average particle size.

The film-forming polymer emulsion has a solids level of from 35 to 60 percent, preferably 45 to 55 percent, although they may be diluted with water as desired. Preferably the viscosity of the emulsion at 50 percent solids is less than 500 cps.

The synthetic polymeric binder of the present invention generally has a Tg in the range of from −60° C. to +50° C., and preferably between −40° and +35° C. One of skill in the art will recognize that the effective Tg of a polymer can be adjusted by use of plasticizers and other additives. The Tg ranges listed are for the effective Tg of the polymer plus any additives effecting the Tg.

The film-forming polymer is present in the binder composition at from 55 to 96 percent by weight, preferably from 70 to 90 percent by weight, based on the solids content of the binder composition. In a preferred embodiment, the polymer is a self-crosslinking ethylene/vinyl acetate or acrylic polymer formed by emulsion polymerization.

The film-forming polymer is combined with one or more opacifying agents to form a binder composition. Opacifying agents useful in the invention include, but are not limited to barium sulfate, titanium dioxide, synthetic (plastic) pigments such as polystyrene and/or styrene acrylic microbeads, tinting dyes, and/or fluorescent whiteners. The opacifying agent or agents are present in the binder composition at from 4 to 45 percent by weight, and preferably from 15 to 30 percent by weight, based on the weight of the binder composition solids.

Other adjuvants may also be present in the binder composition at a level of from 0 to 2 percent. Other additives that may be incorporated into the binder composition include, but are not limited to, suspension aids, thickening agents, parting agents, penetrating agents, wetting agents, thermal gelling agents, sizing agents, defoaming agents, foam suppressors, blowing agents, coloring agents, oxidation inhibitors, quenchers, antiseptic agents, dispersants, antistatic agents, crosslinking agents (to improve wet strength), dispersants, lubricants, plasticizers, pH regulators, flow modifiers, setting promoters, and water-proofing agents, and mixtures thereof.

The polymer emulsion may be combined with the opacifying agent and adjuvants by means known in the art. In one embodiment, the opacifying agent and any adjuvant are slowly added to the emulsion with stirring. To avoid flocculation of the binder or the formation of agglomerates during preparation, it has been found to be advantageous to add the opacifying agent slowly to the emulsion under low shear, followed by gentle mixing for twenty minutes. In another embodiment, the opacifying agent may be added during the emulsion polymerization. Ideally other adjuvants are added after the opacifying agents and under similar conditions. This promotes more homogeneous binders that are ultimately stronger than those produced in other sequences.

Since emulsion polymers have low viscosity, in one preferred embodiment small amounts of suspension aids (e.g., 0.1 to 2%, solids on solids) were found to enhance product homogeneity and storage stability on aging.

The binder composition is a stable system. By stable, as used herein is meant that these compositions remain homogenous and provide the same high level of performance on aging.

The emulsion binders can be used to produce a nonwoven product. A nonwoven product of the present invention is a chemically-bonded dry-formed web, as opposed to a mechanically tangled or thermally bonded web. The web may be formed by any process known in the art, such as a carded, air-laid, dry-laid, wet-laid, or air-formed process. The fibers can be natural, synthetic, or a mixture thereof. The binder is applied to the fiber by any means known in the art, such as print, foam, saturate, coating, and spraying; then dried on steam cans or ovens as currently practiced in the production of nonwoven rolled goods. Binder add-on levels for nonwovens useful in the present invention can be from 0.1 to 100 percent, preferably from 3 to 30 percent. The binder composition of the present invention is especially effective at providing opacity in light basis weight materials. By light basis weight is meant less than or equal to 60 gsm. The non-woven produced with the opacifying binder of the invention remains as a porous substrate.

Nonwovens formed using the binder composition of the present invention are useful in many end-use applications. Dry applications include: dry wipes, disposable medical gowns, and industrial apparel. Nonwovens made with the opacity binder composition are especially useful in applications where wet opacity is desired. Such applications include, but are not limited to, wipes, diapers, napkins, feminine hygiene, medical, and filtration products. Nonwoven wipes may be used in the dry form and wetted just prior to use, or may be pre-moistened with either aqueous or organic solvents as known in the art. Wipes are useful in applications that include household cleaning, personal cleansing, baby wipes, and industrial wipes. Nonwovens of the invention includes both disposable nonwoven products, as well as durable nonwovens such as abrasive pads, medical fabrics, and apparel lining.

The following examples are presented to further illustrate and explain the present invention and should not be taken as limiting in any regard.

### EXAMPLE 1

### Preparation of Nonwoven Binder Composition

Nonwoven binder compositions were prepared by slowly adding the opacifying agent to an emulsion polymer, avoiding a build-up of the opacifying agent. The composition was then allowed to blend for about 20 minutes to assure good dispersion.

A. (Comparative) DUR-O-SET ELITE ULTRA 25-135A, a crosslinkable ethylene-vinyl acetate latex polymer binder containing NMA, Tg=0° C., from National Starch and Chemical Company, with no added opacifying agent.

B. (Comparative) XLINK 25-033A, an vinyl acrylic polymer with a Tg of 20° C. from National Starch and Chemical, with no added opacifying agent.

C. (Comparative) NACRYLIC 25-217A, an acrylic polymer with a Tg of 25° C. from Nacan Products, with no added opacifying agent.

D. DUR-O-SET ELITE ULTRA 25-135A, plus 20 percent DOW 722HS plastic pigment, based on pigment solids on binder solids.

E. DUR-O-SET ELITE ULTRA 25-135A, plus 20 percent barium sulfate, on a solids to binder solids.

F. DUR-O-SET ELITE ULTRA 25-135A, plus 20 percent titanium dioxide on a solids to binder solids.

G. DUR-O-SET ELITE ULTRA 25-135A, plus 16 percent titanium dioxide and 4 percent DOW 722HS plastic pigment, on a solids to binder solids.

H. XLINK 25-033A plus 20 percent DOW 722HS plastic pigment, based on pigment solids on binder solids.

I. NACRYLIC 25-217A plus 20 percent DOW 722HS plastic pigment, based on pigment solids on binder solids.

### EXAMPLE 2

### Preparation of Nonwoven Materials

Dry-Laid:

A dry laid handsheet was saturated with a 20 percent solids opacifying binder composition to about 12 percent binder add-on and oven dried. The sheet was then tested for performance properties. No acid catalyst was used to enhance cross-linking.

Wet-Laid:

A wet laid base sheet comprising a mixture of cellulose fibers, having a basis weight of approximately 32 gsm was saturated with a 20 percent solids opacifying binder composition to about 12 percent binder add-on and oven dried. The sheet was then tested for performance properties. No acid catalyst was used to enhance cross-linking.

### EXAMPLE 3

### Testing and Results

The following tests were performed on the saturated nonwoven materials of Example 2. Testing was done on 20 different samples and the results averaged. Results of the testing are found in Table 1. Standard deviation represents the 95% confidence level.

Opacity:

Dry Opacity is the ability of nonwoven fabric to resist show-through (i.e., its ability to scatter light) as measured by a TECHNIDYNE BRIGHTIMETER MICRO S-5 model BOC and using TAPPI test method T425. A value of 100 percent is completely opaque.

Wet Opacity is the ability for nonwoven to maintain opacity after being soaked in water or lotion using the same methodology above. Samples of the nonwoven materials were soaked in distilled water for 18 hours, blotted between two pieces of Whitman CR4 paper and immediately tested by a TECHNIDYNE BRIGHTIMETER MICRO S-5 model BOC and using TAPPI test method T425. A value of 100% is completely opaque.

Tensile Strength:

Tensile strength is the force required to break a nonwoven fabric in the machine or cross-machine direction as measured by INSTRON model 4468 and using ASTM test method D1682-64. The data is reported for the cross-machine direction and in grams per inch. Wet tensile strength was measured after soaking samples for one (1) minute in distilled water comprising 1% surfactant.

TABLE 1

| | A | B | C | | | | | | |
|---|---|---|---|---|---|---|---|---|---|
| Sample | comp. | comp. | comp. | D | E | F | G | H | I |
| Basis Weight, | 81.9 | 81.7 | 82.1 | 81.5 | 82.5 | 83.1 | 82.6 | 83.6 | 81.7 |
| gsm | | | | | | | | | |
| Binder Add-on, | 19.7 | 21.0 | 21.6 | 19.2 | 20.3 | 22.0 | 19.2 | 20.8 | 21.7 |
| % | | | | | | | | | |
| Dry Opacity | 63.3 | 64.0 | 62.1 | 72.4 | 69.1 | 76.1 | 74.5 | 69.8 | 70.2 |
| Std. deviation | 2.8 | 2.6 | 1.5 | 2.4 | 1.5 | 1.1 | 0.9 | 2.1 | 2.3 |
| Wet Opacity | 45.6 | 46.4 | 42.4 | 56.4 | 51.2 | 67.9 | 66.7 | 53.0 | 50.7 |
| Std. deviation | 3.0 | 1.9 | 2.4 | 1.7 | 1.6 | 3.3 | 1.3 | 1.7 | 1.7 |
| Tensile Strength, | 4285 | 4461 | 4507 | 4603 | 4129 | 4072 | 4167 | 4754 | 4981 |
| Dry, g/in² | | | | | | | | | |
| Std. deviation | 115 | 146 | 213 | 208 | 141 | 159 | 178 | 225 | 296 |
| Tensile Strength, | 2043 | 1734 | 1510 | 2119 | 1888 | 1893 | 1964 | 1593 | 1329 |
| Wet, g/in² | | | | | | | | | |
| Std. deviation | 136 | 113 | 181 | 127 | 90 | 133 | 177 | 134 | 150 |

1. A fibrous nonwoven material comprising chemically bonded fibers wherein said fibers are bonded by a polymeric binder composition, wherein said binder is present in an amount which is sufficient to bind the fibers together to form a self-sustaining web in the presence of fluid, and wherein said binder composition comprises:
a) from 55 to 96 percent by weight of a film-forming polymer, based on the binder composition solids;
b) from 4 to 45 percent by weight of one or more opacifying agents, based on the weight of the binder composition solids; and
c) 0 to 2 percent by weight of one or more adjuvants, based on the binder composition solids.

2. The fibrous material of claim 1 wherein said nonwoven material comprises a chemically-bonded dry-formed nonwoven web.

3. The fibrous material of claim 1 wherein said fibers are natural fibers, synthetic fibers, or a mixture thereof.

4. The fibrous material of claim 1 wherein said opacifying agent is selected from the group consisting of barium sulfate, titanium dioxide, plastic pigment, and mixtures thereof.

5. The fibrous material of claim 1 wherein said opacifying agent is present in the binder composition at from 15 to 30 percent, based on the binder composition solids.

6. The fibrous material of claim 1 wherein said film-forming polymer comprises one or more natural polymers, one or more synthetic polymers, or a mixture thereof.

7. The fibrous material of claim 1 wherein said film-forming polymer comprises a self-crosslinking polymer.

8. The fibrous material of claim 1 wherein said film-forming polymer comprises polyvinyl alcohol, a vinyl acetate/ethylene copolymer, a styrenic polymer, a vinyl acrylic copolymer, an acrylic copolymer, or a mixture thereof.

9. The fibrous material of claim 1 wherein said film-forming polymer comprises a polymer having a Tg of from −40° C. to +35° C.

10. The fibrous material of claim 1 wherein said film-forming polymer comprises an emulsion when applied to the nonwoven material.

11. The fibrous material of claim 1 wherein the polymer binder composition add-on level is from 3 to 30 percent.

12. A nonwoven product comprising the non-woven material of claim 1.

13. The nonwoven product of claim 12 wherein said nonwoven product is selected from the group consisting of a wipe, a diaper, a napkin, a feminine hygiene article, a medical article, and abrasive pad, an apparel lining, and a filtration product.
